(19) United States
(12) Patent Application Publication
(10) Pub. No.: US 2013/0093990 A1
(43) Pub. Date: Apr. 18, 2013

(54) LIQUID CRYSTAL DISPLAY MODULE AND A LIQUID CRYSTAL DISPLAY PANEL

(71) Applicants: Shyhfeng Chen, Shenzhen (CN); Cheng-Hung Chen, Shenzhen (CN); Jinjie Wang, Shenzhen (CN)

(72) Inventors: Shyhfeng Chen, Shenzhen (CN); Cheng-Hung Chen, Shenzhen (CN); Jinjie Wang, Shenzhen (CN)

(73) Assignee: SHENZHEN CHINA STAR OPTOELECTRONICS TECHNOLOGY CO., LTD., Shenzhen (CN)

(21) Appl. No.: 13/376,605

(22) PCT Filed: Oct. 27, 2011
(86) PCT No.: PCT/CN2011/081396

§ 371 Date: Dec. 7, 2011

(30) Foreign Application Priority Data
Oct. 12, 2011 (CN) 201110308358.7

(51) Int. Cl. G02F 1/1345

(52) U.S. Cl. 349/150

(57) ABSTRACT

A liquid crystal display module is provided, which includes a display panel. The display panel disposes a plurality of panel solder pads. Two ends of each panel solder pad both dispose a wire longitudinally extending. The length of each panel solder pad longitudinally extends along a wire direction. The module further includes a FPC board, which has a plurality of FPC board solder pads. The FPC board solder pads and the panel solder pads are soldered together in a one-to-one corresponding relational manner after being aligned with each other by a machine. Two adjacent panel solder pads are stagger arranged along the wire direction. A distance between one panel solder pad and the corresponding wire of the other panel solder pad along the direction perpendicular to the wire is greater than a minimum of an alignment precision of the machine. A liquid crystal display panel is also provided.

### BACKGROUND OF THE INVENTION

1. Field of the Invention

The present invention relates to a technology field of liquid crystal display, and more particularly to a liquid crystal display module and a liquid crystal display panel.

2. Description of the Prior Art

With the continuous development of the liquid crystal display technology, the demand for the function of the liquid crystal display becomes more and more high.

Please refer to FIG. 1, which is a schematic view before a flexible printed circuit (FPC) board 20 and a display panel 10 being pressed together in the prior art. As shown FIG. 1, a solder area of the display panel 10 forms a plurality of panel solder pads 11, and the FPC board 20 forms a plurality of FPC board solder pads 12. The FPC board solder pads 12 are one to one corresponding to the panel solder pads 11 for being ready for a subsequent pressing operation.

Please refer to FIG. 2, which is an enlarged schematic view of a combination of the FPC board solder pads 12 and the panel solder pads 11 after the FPC board being pressed on the display panel in the prior art.

Please refer to FIGS. 1 and 2, the widths S of all panel solder pads 11 on the display panel 10 are equal to each other, and the spaces P between the panel solder pads 11 are also the same as each other. Correspondingly, both the widths of all FPC board solder pads 12 on the FPC 20 and the spaces therebetween are also the same.

In the prior art, both the panel solder pads 11 and the FPC board solder pads 12 are symmetrically arranged in one row. The machine (not shown in all FIGS.) may align the panel solder pads 11 with the FPC board solder pads 12 by an alignment mark 13 located on two sides of the display panel and the FPC board, and then presses them together. An offset exists during the alignment by the machine. But when the resolution of the display panel is low, both the widths S and the spaces P of the panel solder pads 11 are greater. Therefore, though some offset exists, the signal transmission of the display panel cannot be effected by it.

But with the improvement of the image displaying quality and effect of a thin film transistor-liquid crystal display (TFT-LCD) product, this high-resolution product becomes more and more attractive. If wanted to improve the resolution of the display panel, the space P between the panel solder pads 11 must be reduced. Now, the same offset of the machine will make the panel solder pads 11 and the FPC board solder pads 12 be misaligned so that resulting in the signal transmission being abnormal.

Please refer to FIG. 3, which is a schematic view after reducing the spaces P of the panel solder pads 11. Suppose the alignment precision of the machine is 4 um, the width S of each panel solder pad 11 is 10 um and the space P between each two adjacent panel solder pads 11 is 5 um (greater than 4 um), only four panel solder pads may be placed within the range of 55 um, and only five panel solder pads may be placed within the range of 70 um.

Moreover, it can be seen from FIG. 3 that: because the spaces P between the panel solder pads 11 are reduced and the panel solder pads 11 are placed too near each other, when the FPC board solder pad 12 is pressed onto the corresponding panel solder pad 11 by the machine, the FPC board solder pad 12 is very easy to overlap the adjacent panel solder pad 11 due to the existing of the offset so that resulting in the error soldering, the signals being interfered each other and the image being abnormally displayed.

### BRIEF SUMMARY OF THE INVENTION

The present invention provides a liquid crystal display module and a liquid crystal display panel to solve the technical problems of how to not only improve the use efficiency of a solder area of a display panel, but also avoid the solder pads overlapped in error due to an offset existing in the machine so that resulting in the signals being interfered each other and the image being abnormally displayed.

An object of the present invention is to provide a liquid crystal display module comprising a display panel. The display panel disposes a plurality of panel solder pads, two ends of each of which both dispose a wire longitudinally extending. The length of each panel solder pad longitudinally extends along a wire direction.

The liquid crystal display module further comprises a FPC board. The FPC board includes a plurality of FPC board solder pads. The FPC board solder pads and the panel solder pads are soldered together in a one-to-one corresponding relational manner after being aligned with each other by a machine.

Two of the panel solder pads orderly arranged in a direction perpendicular to the wire direction are stagger arranged along the wire direction. And a distance between one panel solder pad and the corresponding wire of the other panel solder pad along the direction perpendicular to the wire is greater than a minimum of an alignment precision of the machine.

At least two of the panel solder pads orderly arranged in the direction perpendicular to the wire direction and the wires located on the at least two of panel solder pads constitute one solder group, so that forming multiple solder groups orderly arranged along the direction perpendicular to the wire direction.

The display panel disposes an alignment mark, which can make the panel solder pads be aligned with the corresponding FPC board solder pad.

In the liquid crystal display module of the present invention, the widths of all panel solder pads on the display panel are the same, the widths of all FPC solder pads are the same, and the widths of the panel solder pads and the FPC solder pads are also the same.

In the liquid crystal display module of the present invention, the panel solder pads are connected to the FPC board solder pads by a conductive adhesive.

To achieve the aforementioned object or other objects of the present invention, the present invention also adopts the following technical solution.

A liquid crystal display module and a liquid crystal display panel are provided to improve the use efficiency of a solder area of a display panel and avoid the solder pads to overlap in error due to an offset existing in the machine, so that safely increasing the high resolution and assuring the quality and the effect of displaying image.

To achieve the aforementioned object or other objects of the present invention, the present invention also adopts the following technical solution. A liquid crystal display module comprises a display panel. The display panel disposes a plurality of panel solder pads, two ends of each of which both dispose a wire longitudinally extending. Wherein the length of each panel solder pad longitudinally extends along a wire direction.

The liquid crystal display module further comprises a FPC board. The FPC board includes a plurality of FPC board solder pads. The FPC board solder pads and the panel solder pads are soldered together in a one-to-one corresponding relational manner after being aligned with each other by a machine.

Two of the panel solder pads orderly arranged in a direction perpendicular to the wire direction are stagger arranged along the wire direction. And a distance between one panel solder pad and the corresponding wire of the other panel solder pad along the direction perpendicular to the wire is greater than a minimum of an alignment precision of the machine.

In the liquid crystal display module of the present invention, at least two of the panel solder pads orderly arranged in the direction perpendicular to the wire direction and the wires located on the at least two of panel solder pads constitute one solder group, so that forming multiple solder groups orderly arranged along the direction perpendicular to the wire direction.

In each solder group, the at least two of the panel solder pads orderly arranged in the direction perpendicular to the wire direction are stagger arranged along the wire direction.

In the liquid crystal display module of the present invention, the display panel disposes an alignment mark, which can make the panel solder pads be aligned with the corresponding FPC board solder pad.

In the liquid crystal display module of the present invention, the widths of all panel solder pads on the display panel are the same, the widths of all FPC solder pads are the same, and the widths of the panel solder pads and the FPC solder pads are also the same.

In the liquid crystal display module of the present invention, the panel solder pads are connected to the FPC board solder pads by a conductive adhesive.

To achieve the aforementioned object or other objects of the present invention, the present invention also adopts the following technical solution. A liquid crystal display panel comprises a plurality of panel solder pads, two ends of each of which both dispose a wire longitudinally extending. Wherein the length of each panel solder pad longitudinally extends along a wire direction.

Two of the panel solder pads orderly arranged in a direction perpendicular to the wire direction are stagger arranged along the wire direction. And a distance between one panel solder pad and the corresponding wire of the other panel solder pad along the direction perpendicular to the wire is greater than a minimum of an alignment precision of the machine.

In the liquid crystal display panel of the present invention, at least two of the panel solder pads orderly arranged in the direction perpendicular to the wire direction and the corresponding wires constitute one solder group, so that forming multiple solder groups orderly arranged along the direction perpendicular to the wire direction.

In each solder group, the at least two of the panel solder pads orderly arranged in the direction perpendicular to the wire direction are stagger arranged along the wire direction.

In the liquid crystal display panel of the present invention, the display panel disposes an alignment mark, which can make the panel solder pads be aligned with the corresponding FPC board solder pad.

In the liquid crystal display panel of the present invention, the widths of all panel solder pads on the display panel are the same, the widths of all FPC solder pads are the same, and the widths of the panel solder pads and the FPC solder pads are also the same.

In the liquid crystal display panel of the present invention, the panel solder pads are connected to the FPC board solder pads by a conductive adhesive.

Comparing with the prior art, a liquid crystal display module and a liquid crystal display panel provided by the present invention can make the two adjacent panel solder pads be stagger arranged in the wire direction, thereby improving the use efficiency of the solder area of the liquid crystal display panel and avoiding the FPC board to overlap in error due to an offset existing in the machine, safely increasing the high resolution and assuring the quality and the effect of displaying image.

For more clearly and easily understanding above content of the present invention, the following text will take a preferred embodiment of the present invention with reference to the accompanying drawings for detail description as follows.

### BRIEF DESCRIPTION OF THE DRAWINGS

FIG. 1 is a schematic view before a FPC board and a display panel being pressed together in the prior art;

FIG. 2 is an enlarged schematic view of a combination of the FPC board solder pads and the panel solder pads after the FPC board being pressed on the display panel in the prior art;

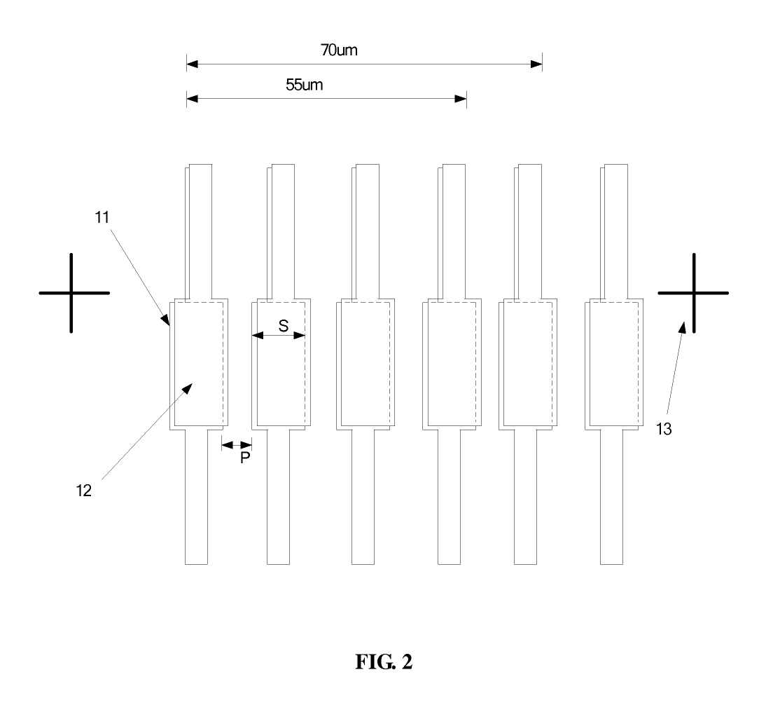

FIG. 3 is a soldering schematic view after reducing the spaces between the panel solder pads in the prior art;

FIG. 4 is a structure view of a first preferred embodiment of a liquid crystal display module of the present invention;

FIG. 5 is a schematic view of an enlarged structure of one of solder groups in FIG. 4;

FIG. 6 is a structure view of a second preferred embodiment of a liquid crystal display module of the present invention; and

FIG. 7 is a schematic view of an enlarged structure of one of solder groups in FIG. 6.

### DETAILED DESCRIPTION OF THE PREFERRED EMBODIMENTS

The following description of every embodiment with reference to the accompanying drawings is used to exemplify a specific embodiment, which may be carried out in the present invention.

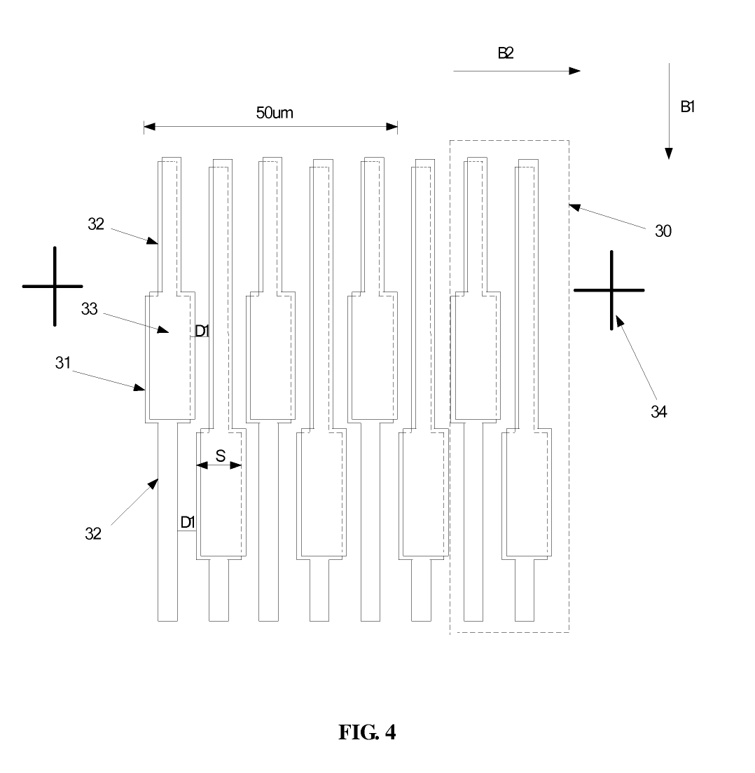

FIG. 4 is a structure view of a first preferred embodiment of a liquid crystal display module of the present invention;

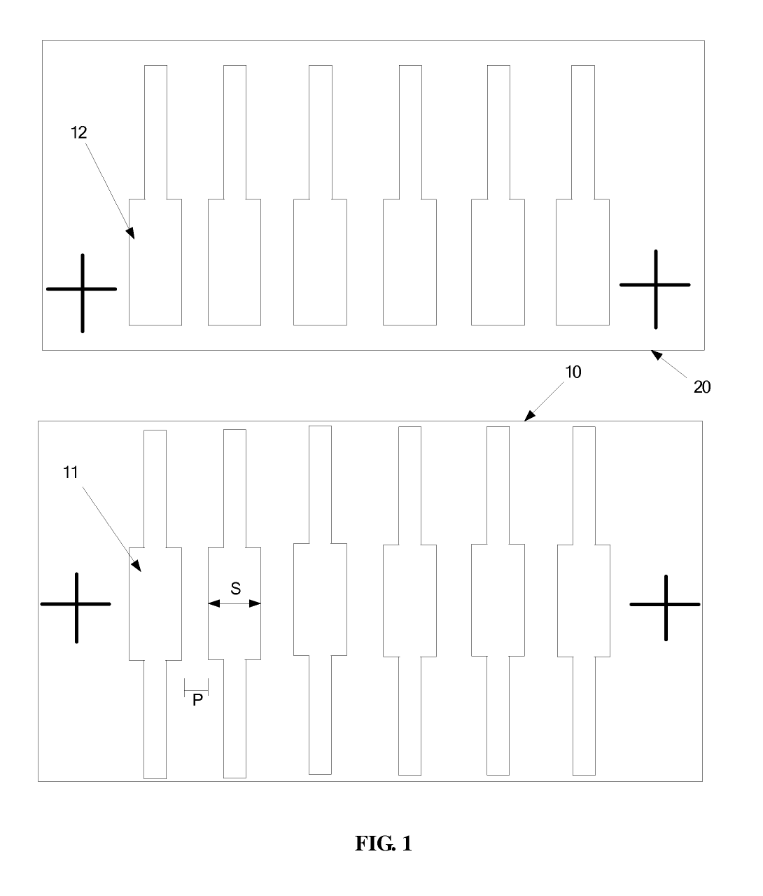

Please refer to FIG. 4, the liquid crystal display module comprises a display panel (referring to the display panel 10 of FIG. 1). The display panel disposes a plurality of panel solder pads 31, two ends of each of which both dispose a wire 32 longitudinally extending. The length of each panel solder pad 31 extends along the wire direction (namely a longitudinal direction B1 shown in FIG. 4).

Please continuously refer to FIG. 4, the liquid crystal display module further comprises at least one FPC board (referring to the FPC board 20 of FIG. 1). The FPC board includes a plurality of FPC board solder pads 33. The FPC board solder pads 33 and the panel solder pads 31 are aligned with each other by the machine and then are soldered together in a one-to-one corresponding relational manner. Wherein, the display panel disposes an alignment mark 34, so the machine may align the panel solder pads 31 with the FPC board solder pads 33 by the alignment mark 13.

In this embodiment, the widths S of all panel solder pads 31 on the display panel are the same as each other. Correspondingly, the widths S of all FPC board solder pads 33 are also the same as each other. And the widths S of the panel solder pads 31 and the FPC board solder pads 33 are also the same.

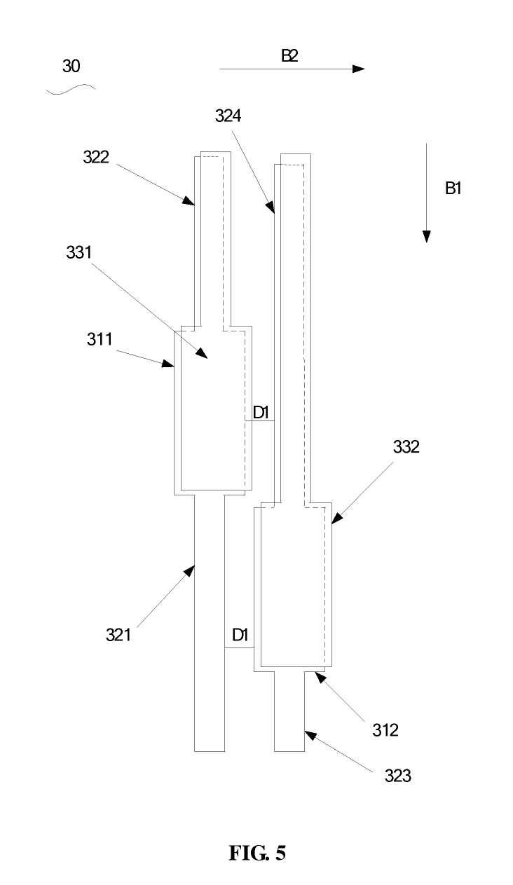

Please refer to FIGS. 4 and 5, in a direction (namely a transverse direction B2 shown in FIGS. 4 and 5) perpendicular to the direction of the wire, each two adjacent panel solder pads, two corresponding FPC board solder pads and the wires located on two ends of these solder pads constitute a solder group 30 arranged along the transverse direction B2. Specifically, each solder group 30 includes a first panel solder pad 311, a second panel solder pad 312, a first FPC board solder pad 331 corresponding to the first panel solder pad 311, and a second FPC board solder pad 332 corresponding to the second panel solder pad 312. Each solder group 30 further includes a first wire 321 and a second wire 322 being respectively connected to two opposite ends of the first panel solder pad 311, and a third wire 323 and a fourth wire 324 being respectively connected to two opposite ends of the second panel solder pad 312.

Wherein, the first wire 321, the second panel solder pad 312 and the third wire 323 are located on a same side of the first panel solder pad 311 along the longitudinal direction B1. The second wire 322, the first panel solder pad 311 and the fourth wire 324 are located on a same side of the second panel solder pad 312 along the longitudinal direction B1.

More detailledly, in the embodiment shown FIG. 5, the first panel solder pad 311 and the second panel solder pad 312, which are orderly arranged along the transverse direction B2, are stagger arranged in the longitudinal direction B1. Correspondingly, the first FPC board solder pad 331 and the second FPC board solder pad 332 are stagger arranged in the longitudinal direction B1.

In the embodiment shown FIG. 5, a distance between the first panel solder pad 311 and the fourth wire 324 along the transverse direction B2 is D1, which is greater than a minimum of the alignment precision of the machine. For example, if the range of the alignment precision of the machine is 4 um to 5 um, the distance D1 need be greater than 4 um. Because the widths of the first and second panel solder pads 311, 312 are the same, the distance between the second panel solder pad 312 and the first wire 321 along the transverse direction B2 is also D1.

In the concrete implementation, the positions of the first and second panel solder pads 311, 312 can be exchanged each other. The structure after exchanged the positions thereof is similar to the inverted structure of the embodiment shown in FIG. 5, so no more repeated here.

In the concrete implementation, there employs a conductive adhesive (not shown in all FIGS.) for connecting the first panel solder pad 311 with the first FPC board solder pad 331, and connecting the second panel solder pad 312 with the second FPC board solder pad 332.

The working principle of the first embodiment of the liquid crystal display module shown in FIG. 4 is as following:

Please refer to FIGS. 4 and 5, when the FPC board solder pads 33 are soldered on the panel solder pads 31, and one solder group 30 shown in FIG. 5 is as an example, first the surfaces of the first and second panel solder pads 311, 312 are coated with the conductive adhesive.

After that, the first FPC board solder pads 331 are aligned with and then pressed unto the first panel solder pads 311 by the machine. At the same time, the second FPC board solder pads 331 are aligned with and then pressed unto the second panel solder pads 312.

In the above alignment operation, the machine employs the alignment mark 34 of the display panel to align the panel solder pads 31 with the FPC board solder pads 33.

Wherein, because the first and second panel solder pads 311, 312 are stagger arranged in the longitudinal direction B1, and the first and second FPC board solder pads 331, 332 are also stagger arranged in the longitudinal direction B1, the error overlapping occurring due to the offset can be efficiently avoided.

Moreover, the distance D1 between the first panel solder pad 311 and the fourth wire 324 along the transverse direction B2 is greater than the minimum of the alignment precision, and the widths of the first FPC board solder pad 331 and the first panel solder pad 311 are the same. Accordingly, when the first FPC board solder pad 331 is pressed onto the first panel solder pad 311, even if the first FPC board solder pad 331 produces the offset, it will not occur that the first FPC board solder pad 331 overlaps the fourth wire 324.

Similarly, the second FPC board solder pad 332 is pressed onto the second panel solder pad 312, and the distance D1 between the second panel solder pad 312 and the first wire 321 is also greater than the minimum of the alignment precision. Accordingly, when the second FPC board solder pad 332 is pressed onto the second panel solder pad 312, even if the second FPC board solder pad 332 produces the offset, it will not occur that the second FPC board solder pad 332 overlaps the first wire 321. Obviously, this embodiment can avoid the problem of the error overlapping and soldering, so that efficiently avoiding the signals being interfered each other and assuring the image displaying quality.

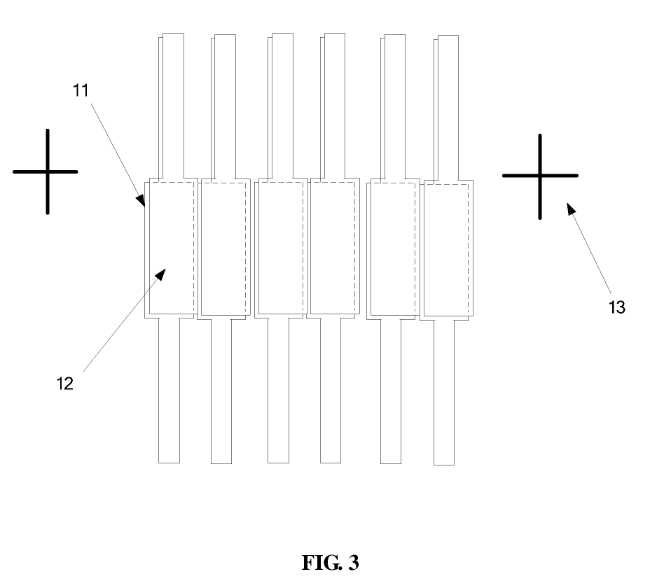

For example, please refer to FIGS. 4 and 5, suppose the alignment precision of the machine is 4 um, the distance D1 between the first panel solder pad 311 and the fourth wire 324 is 5 um and the width S of the panel solder pad 31 is 10 um, so that five panel solder pads 31 may be placed within the range of 50 um. Compared with the prior art shown in FIG. 3, in the same space, this embodiment may arrange more panel solder pads 31 so that realizing the solder area design of the display panel of the high resolution under the condition of no reducing the width S of the panel solder pad 31. Moreover, the distance D1 between the panel solder pad 31 and the adjacent wire 32 is greater than the minimum of the alignment precision, so that efficiently avoiding the problem of the error overlapping and soldering, avoiding the signals to be interfered each other and assuring the image displaying quality.

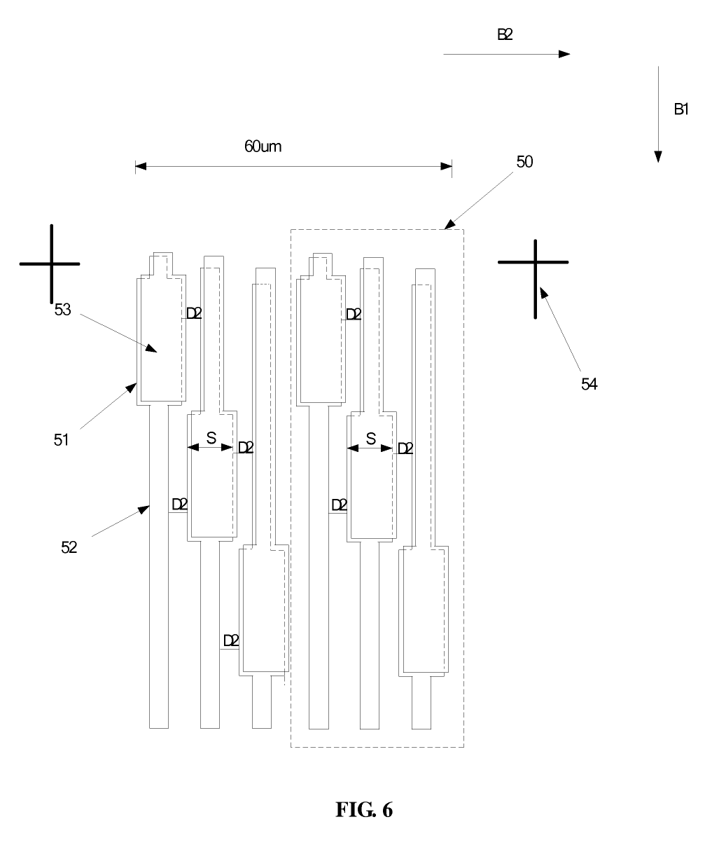

FIG. 6 is a structure view of a second preferred embodiment of the liquid crystal display module in the present invention.

The liquid crystal display module comprises a display panel (referring to the display panel 10 of FIG. 1). The display panel disposes a plurality of panel solder pads 51. The length of each panel solder pad 51 extends along the longitudinal direction B1. Two ends of each panel solder pad 51 both dispose a wire 52.

Please continuously refer to FIG. 6, the liquid crystal display module further comprises a FPC board (referring to the FPC board 20 of FIG. 1). The FPC board includes a plurality of FPC board solder pads 53. The FPC board solder pads 53 and the panel solder pads 51 are soldered together in a one-to-one corresponding relational manner after being aligned with each other by the machine. Wherein, the display panel disposes an alignment mark 54, so the machine may align the panel solder pads 51 with the FPC board solder pads 53 by the alignment mark 54.

Wherein, the widths S of all panel solder pads 31 on the display panel are the same as each other. Correspondingly, the widths S of all FPC board solder pads 33 are also the same as each other. And the widths S of the panel solder pads 31 and the FPC board solder pads 33 are also the same.

In the concrete implementation, the panel solder pads 51 are connected to the FPC board solder pads 53 by a conductive adhesive (not shown in all FIGS.).

The difference between the first preferred embodiment shown in FIGS. 4 and 5 and the second embodiment shown in FIG. 6 is that: in the embodiment shown in FIG. 6, each solder group 50 consists of three panel solder pads and three corresponding FPC board solder pads, which are arranged along the direction (namely the transverse direction B2) perpendicular to the direction of the wire, and the wires located on two ends of these solder pads. Wherein, multiple solder groups 50 are orderly arranged along the transverse direction B2. In each solder group 50, the three panel solder pads orderly arranged along the transverse directive B2 are extending along the wire direction (namely the longitudinal direction B1) and are stagger arranged in the longitudinal direction B1.

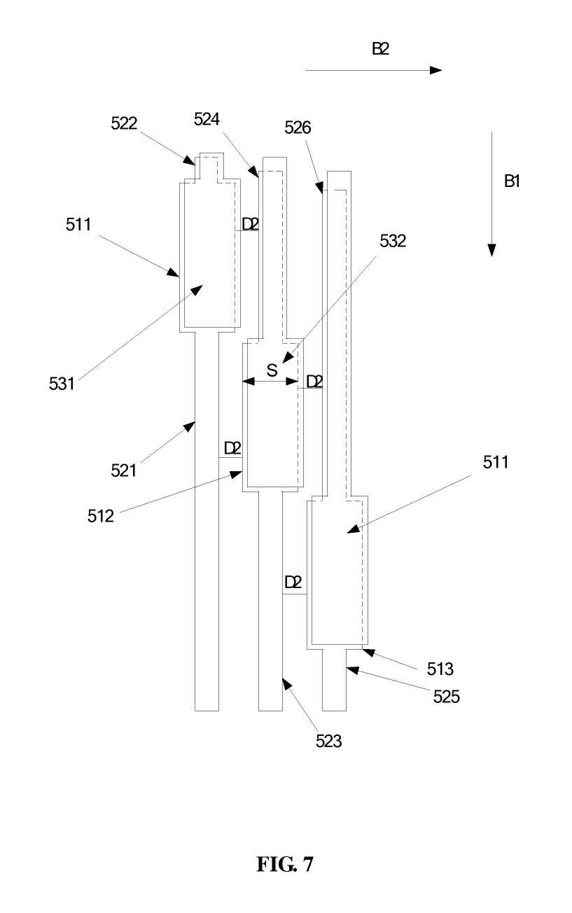

Please refer to FIG. 7, each solder group 50 includes a first panel solder pad 511, a second panel solder pad 512 and a third panel solder pad 513. The liquid crystal display module also includes a first FPC board solder pad 531, a second FPC board solder pad 532 and a third FPC board solder pad 533, which are corresponding to the first panel solder pad 511, the second panel solder pad 512 and the third panel solder pad 513, respectively.

Please refer to FIG. 7, the liquid crystal display module further includes a first wire 521 and a second wire 522 connected to the first panel solder pad 511, a third wire 523 and a fourth wire 524 connected to the second panel solder pad 512, and a fifth wire 525 and a sixth wire 526 connected to the third panel solder pad 513.

In the embodiment shown in FIG. 6, a distance between the first panel solder pad 511 and the fourth wire 524 along the transverse direction B2 is D2, which is greater than the minimum of the alignment precision. For example, if the range of the alignment precision is 4 um to 5 um, D2 is greater than 4 um. A distance between the second panel solder pad 512 and the first wire 521 is also D2, and a distance between the third panel solder pad 513 and the third wire 523 is also D2.

The design principle of the structure of the second preferred embodiment shown in FIG. 6 is similar to that of the first preferred embodiment shown in FIG. 4, so no more repeated here.

Please refer to FIGS. 6 and 7, suppose the alignment precision of the machine is 4 um, the distance D2 between the first panel solder pad 511 and the fourth wire 534 is 5 um and the width S of the panel solder pad 51 is 10 um, so that six panel solder pads 51 may be placed within the range of 60 um. Compared with the prior art shown in FIG. 3, in the same space, this embodiment may arrange more panel solder pads 51 so that realizing the solder area design of the display panel of the high resolution under the condition of no reducing the width S of the panel solder pad 51. Moreover, the distance D2 between the panel solder pad 51 and the adjacent wire 52 is greater than the minimum of the alignment precision, so that efficiently avoiding the problem of the error overlapping and soldering, avoiding the signals to be interfered each other and assuring the image displaying quality.

The present invention further provides a liquid crystal display panel, which comprises a plurality of panel solder pads, two ends of each of which both dispose a wire longitudinally extending. The length of the panel solder pad longitudinally extends along the wire direction. Two panel solder pads orderly arranged along the direction perpendicular to the wire are stagger arranged along the wire direction. And the distance between one panel solder pad and the corresponding wire of the other panel solder pad along the direction perpendicular to the wire is greater than the minimum of the alignment precision.

In the concrete implementation, at least two panel solder pads orderly arranged in the direction perpendicular to the wire direction and the corresponding wires constitute a solder group. Multiple solder groups are orderly arranged along the direction perpendicular to the wire direction. In each solder group, the at least two panel solder pads orderly arranged in the direction perpendicular to the wire direction are stagger arranged along the wire direction.

In the concrete implementation, the display panel disposes an alignment mark, so the machine can align the panel solder pads with the FPC board solder pads by the alignment mark.

In the concrete implementation, the widths S of all panel solder pads on the display panel are the same as each other and the widths S of all FPC board solder pads are also the same as each other. And the widths S of the panel solder pads and the FPC board solder pads are also the same.

In the concrete implementation, the panel solder pads are connected to the FPC board solder pads by a conductive adhesive.

Because the liquid crystal display panel and the FPC board have been detailed described in the above text, the liquid crystal display panel is no more described here.

In conclusion, although the present invention has been disclosed by above preferred embodiments, above preferred embodiments are not used to limit the present invention. One of ordinary skills in the art also can make all sorts of improvements and amendments within the principles of the present invention. Therefore, the protection scope of the present invention should be based on the scope defined by the appended claims.

What is claimed is:

1. A liquid crystal display module, comprising a display panel, the display panel disposing a plurality of panel solder pads, two ends of each of which both dispose a wire longitudinally extending, wherein the length of each panel solder pad longitudinally extending along a wire direction;
the liquid crystal display module further comprising a FPC board, the FPC board including a plurality of FPC board solder pads, the FPC board solder pads and the panel solder pads being soldered together in a one-to-one corresponding relational manner after being aligned with each other by a machine; characterized in that:
two of the panel solder pads orderly arranged in a direction perpendicular to the wire direction being stagger arranged along the wire direction, and a distance between one panel solder pad and the corresponding wire of the other panel solder pad along the direction perpendicular to the wire being greater than a minimum of an alignment precision of the machine;
at least two of the panel solder pads orderly arranged in the direction perpendicular to the wire direction and the wires located on the at least two of panel solder pads constituting one solder group, so that forming multiple solder groups orderly arranged along the direction perpendicular to the wire direction; and
the display panel disposing an alignment mark, which can make the panel solder pads be aligned with the corresponding FPC board solder pad.

2. The liquid crystal display module as claimed in claim 1, characterized in that: the widths of all panel solder pads on the display panel are the same, the widths of all FPC solder pads are the same, and the widths of the panel solder pads and the FPC solder pads are also the same.

3. The liquid crystal display module as claimed in claim 1, characterized in that: the panel solder pads are connected to the FPC board solder pads by a conductive adhesive.

4. A liquid crystal display module, comprising a display panel, the display panel disposing a plurality of panel solder pads, two ends of each of which both dispose a wire longitudinally extending, wherein the length of each panel solder pad longitudinally extending along a wire direction;
the liquid crystal display module further comprising a FPC board, the FPC board including a plurality of FPC board solder pads, the FPC board solder pads and the panel solder pads being soldered together in a one-to-one corresponding relational manner after being aligned with each other by a machine; characterized in that:
two of the panel solder pads orderly arranged in a direction perpendicular to the wire direction being stagger arranged along the wire direction, and a distance between one panel solder pad and the corresponding wire of the other panel solder pad along the direction perpendicular to the wire being greater than a minimum of an alignment precision of the machine.

5. The liquid crystal display module as claimed in claim 4, characterized in that: at least two of the panel solder pads orderly arranged in the direction perpendicular to the wire direction and the wires located on the at least two of panel solder pads constitute one solder group, so that forming multiple solder groups orderly arranged along the direction perpendicular to the wire direction; and
in each solder group, the at least two of the panel solder pads orderly arranged in the direction perpendicular to the wire direction are stagger arranged along the wire direction.

6. The liquid crystal display module as claimed in claim 4, characterized in that: the display panel disposes an alignment mark, which can make the panel solder pads be aligned with the corresponding FPC board solder pad.

7. The liquid crystal display module as claimed in claim 4, characterized in that: the widths of all panel solder pads on the display panel are the same, the widths of all FPC solder pads are the same, and the widths of the panel solder pads and the FPC solder pads are also the same.

8. The liquid crystal display module as claimed in claim 4, characterized in that: the panel solder pads are connected to the FPC board solder pads by a conductive adhesive.

9. A liquid crystal display panel, comprising a plurality of panel solder pads, two ends of each panel solder pad disposing a wire longitudinally extending, the length of each panel solder pad longitudinally extending along a wire direction; characterized in that:
two of the panel solder pads orderly arranged in a direction perpendicular to the wire direction being stagger arranged along the wire direction, and a distance between one panel solder pad and the corresponding wire of the other panel solder pad along the direction perpendicular to the wire being greater than a minimum of an alignment precision of the machine.

10. The liquid crystal display panel as claimed in claim 9, characterized in that: at least two of the panel solder pads orderly arranged in the direction perpendicular to the wire direction and the wires located on the at least two of panel solder pads constitute one solder group, so that forming multiple solder groups orderly arranged along the direction perpendicular to the wire direction; and
in each solder group, the at least two of the panel solder pads orderly arranged in the direction perpendicular to the wire direction are stagger arranged along the wire direction.

11. The liquid crystal display panel as claimed in claim 9, characterized in that: the display panel disposes an alignment mark, which can make the panel solder pads be aligned with FPC board solder pads located on a FPC board.

12. The liquid crystal display panel as claimed in claim 11, characterized in that: the widths of all panel solder pads on the display panel are the same, the widths of all FPC solder pads are the same, and the widths of the panel solder pads and the FPC solder pads are also the same.

13. The liquid crystal display panel as claimed in claim 11, characterized in that: the panel solder pads are connected to the FPC board solder pads by a conductive adhesive.
